(19) United States
(12) Patent Application Publication
(10) Pub. No.: US 2012/0271587 A1
(43) Pub. Date: Oct. 25, 2012

(54) EQUIPMENT STATUS MONITORING METHOD, MONITORING SYSTEM, AND MONITORING PROGRAM

(75) Inventors: Hisae Shibuya, Chigasaki (JP); Shunji Maeda, Yokohama (JP)

(73) Assignee: Hitachi, Ltd., Tokyo (JP)

(21) Appl. No.: 13/500,932

(22) PCT Filed: Jun. 16, 2010
(86) PCT No.: PCT/JP2010/060234

§ 371 Date: Jun. 27, 2012

(30) Foreign Application Priority Data
Oct. 9, 2009 (JP) 2009-235020

(51) Int. Cl. G06F 15/00

(52) U.S. Cl. 702/127

(57) ABSTRACT

Anomaly sign detection methods such as those found in plants cannot detect anomalies when relevant sensor information is not acquired, and while it is possible to detect anomalies through changes in sensor output when manual operations are performed, it is difficult to distinguish between anomalies such as those caused only by the sensor signal and actual anomalies which should be detected. The disclosed method uses event signals, which contain a signal based on the status of a unit unable to acquire sensor information and a signal based on human operations. An event sequence is extracted from an event signal outputted from a piece of equipment and grouped by clustering, then a frequency matrix is created for the alarms generated within a prescribed interval of an event sequence, and a prediction of alarms with a high probability of occurring for an event sequence is output on the basis of the frequency matrix.

### TECHNICAL FIELD

The present invention relates to an equipment status monitoring method, a monitoring system and a monitoring program to early detect an anomaly on the basis of multidimensional time series data periodically output from a plant, a piece of equipment or the like and event data intermittently output therefrom.

### BACKGROUND ART

Electric power companies use waste heat from gas turbines and the like to provide hot water for local heating and to provide high pressure steam and low pressure steam for factories. Petrochemical companies operate gas turbines and the like as power source equipment. In various types of plants and equipment using gas turbines and the like, preventive maintenance for detecting malfunctions of the equipment or the signs thereof is significantly important for the sake of minimizing damage to the society.

In addition to gas turbines and steam turbines, there are many pieces of equipment requiring the preventive maintenance, including water turbines in hydroelectric power plants, nuclear reactors in nuclear power plants, wind turbines in wind power plants, engines in aircraft and heavy equipment, railway vehicles, railways, escalators, and elevators, and on a component and part level, the preventive maintenance is also required with respect to deterioration and lifetimes of on-board batteries.

Thus, Patent Literatures 1 and 2 disclose an anomaly detection method directed to engines. These methods include preliminarily holding previous data, such as time series sensor signals, in a database, using a unique method to calculate the similarity between observed data and previous learned data, calculating an estimation value by means of linear combination of data with high similarity, and outputting a degree of deviation between the estimation value and the observed data.

Further, Patent Literature 3 discloses a plant security management system that stores causality between a process anomaly event and an apparatus damage event.

### CITATION LIST

### Patent Literature

Patent Literature 1: U.S. Pat. No. 6,952,662
Patent Literature 2: U.S. Pat. No. 6,975,962
Patent Literature 3: Japanese Patent Laid-Open
Publication No. 2009-20787

### Non Patent Literature

Non Patent Literature 1: Stephan W. Wegerich;
Nonparametric modeling of vibration signal features for equipment health monitoring, Aerospace Conference, 2003. Proceedings. 2003 IEEE, Volume 7, Issue, 2003 Page(s): 3113-3121

### SUMMARY OF INVENTION

### Technical Problem

The methods described in Patent Literatures 1 and 2 and many other anomaly detecting methods are for detecting an anomaly using time series sensor information. Accordingly, without acquisition of relevant sensor information, an anomaly cannot be detected. This may be the case when a unit embedded in equipment outputs only either normal or anomaly status. There is a possibility that a manual operation changes a sensor output, which may be detected as an anomaly. It is difficult to distinguish such an anomaly from an actual anomaly to be detected only from the sensor signal.

The method described in Patent Literature 3 includes storing the causality between the process anomaly events indicating anomalies in temperature, pressure and electric power at a specific location and apparatus damage events indicating failures at the specific location. However, this method defines a subdivided single anomaly as the process anomaly event. Accordingly, it is difficult to extract significant causality unless there is one-to-one correspondence between the process anomaly event and the apparatus damage event. Further, events indicating manual operations are not defined, causing a problem similar to the problem described above.

It is an object of the present invention to solve the above problems and provide an equipment status monitoring method and system that can detect an anomaly sign even if sensor information of some units cannot be acquired. It is another object to provide an equipment status monitoring method and system that are adjustable so as not to detect an anomaly of a sensor output due to a manual operation.

### Solution to Problem

In order to attain the object, in equipment status monitoring based on a time series sensor signal and event signal output from equipment, a manufacturing device or a measurement device, the present invention uses an event signal including a signal based on the status of a unit incapable of acquiring sensor information or a signal based on a human operation. More specifically, event sequences are extracted from the event signal output from the equipment. The event sequences are grouped by clustering based on similarity. A frequency matrix is created for the event sequence and a failure event occurred until a prescribed time has elapsed. The event sequence similar to the observed event sequence is searched for, on test. If there is a failure event having high probability of occurring within the prescribed time, prediction of the failure is issued on the basis of the frequency matrix.

In equipment status monitoring based on a time series sensor signal and event signal output from equipment, a manufacturing device or a measurement device, a normal state model is created on the basis of a multidimensional sensor signal. An anomaly measure is calculated on the basis of comparison between the normal state model and the sensor signal. While an anomaly is identified, event sequences are extracted from the event signal output from the equipment. The event sequences are grouped by clustering based on the similarity. Correlation between the average of anomaly measure in each certain period and presence or absence of the event sequence is acquired. It is set so as not to use, for creating the normal state model, the sensor signal data in a period including the event sequence having a significantly high anomaly measure.

The event sequence having the significantly high anomaly measure is given a designation to indicate whether it represents a manual operation or not. Any observed event sequence similar to the event sequence representing a manual operation is not determined to be an anomaly even with a high anomaly measure.

### Advantageous Effects of Invention

According to the present invention, in equipment status monitoring, association between the event sequence and the failure is acquired by the frequency matrix, thereby allowing anomaly prediction by searching for the event sequence even on the failure in a unit incapable of acquiring sensor information. The occurred events are captured as an event sequence instead of individual events, thereby facilitating understanding of the significance of the occurred event. Further, instead of using the event sequences as they are, the event sequences are grouped to reduce the number of rows of the frequency matrix, thereby allowing statistically significant information to be increased.

The correlation between the event sequence and the anomaly measure derived from the sensor signal is prepared, and data in a period during which the event sequence having a high anomaly measure is present is excluded from the normal state model creation. Accordingly, it is possible to remove the data including changes in the sensor signal occurred for some reason such as a manual operation, thereby enabling a highly accurate normal state model to be created. Designation of the event sequence representing a manual operation can prevent an anomaly of a sensor output due to a manual operation from being detected.

As described above, it is possible by the use of the event sequence to acquire advantageous effects that cannot be acquired only from analysis of the sensor signal, and to highly accurately detect an anomaly and an anomaly sign of equipment, not only gas turbines and steam turbines, but also water turbines in hydroelectric power plants, nuclear reactors in nuclear power plants, wind turbines in wind power plants, engines in aircraft and heavy equipment, railway vehicles, railways, escalators, elevators, and on a component and part level, deterioration and lifetimes of on-board batteries.

### BRIEF DESCRIPTION OF DRAWINGS

FIG. 1 shows an example of a configuration of an equipment status monitoring system of the present invention.

FIG. 2 shows an example of an event signal.

FIG. 3 shows an example of a sensor signal.

FIG. 4 shows an example of a normal state model creation processing flow.

FIG. 5 is a diagram illustrating a projection distance method.

FIG. 6 is a diagram illustrating a local sub-space classifier.

FIG. 7 shows a processing flow for learning causality between an event sequence and an alarm.

FIG. 8 is a diagram illustrating a frequency matrix of the event sequence and the alarm.

FIG. 9 shows a processing flow for predicting an anomaly using the event signal.

FIG. 10 shows an example of an alarm occurrence prediction result display screen.

FIG. 11 shows another example of a configuration of an equipment status monitoring system of the present invention.

FIG. 12 shows a processing flow for learning correlation between the event sequence and an anomaly measure.

FIG. 13 shows a processing flow for determining an exception of anomaly identification using the event signal.

### DESCRIPTION OF EMBODIMENTS

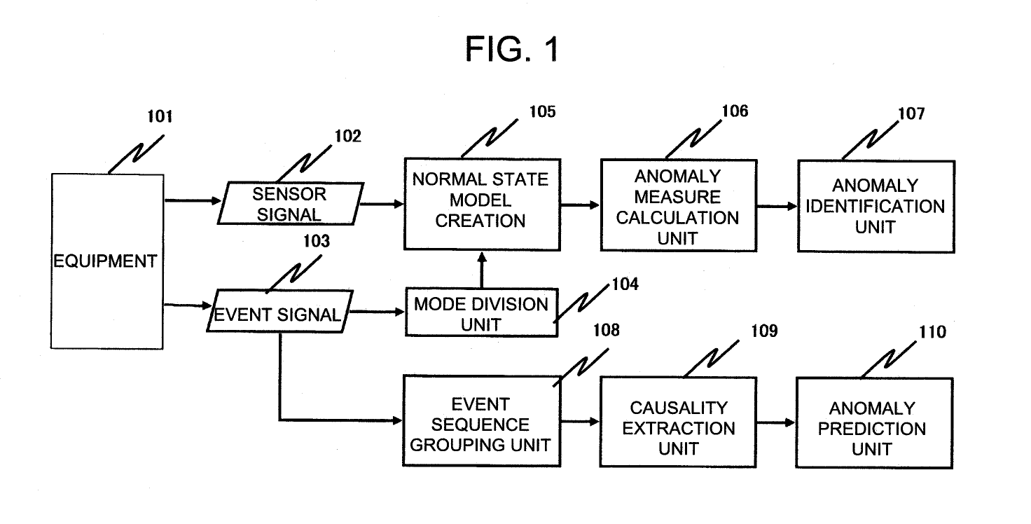

The contents of the present invention will hereinafter be described in detail. FIG. 1 shows an example of a configuration of a system realizing an equipment status monitoring method of the present invention. The operation of this system includes two phases, which are “learning” that preliminarily creates a model to be used for detecting and diagnosing an anomaly sign, and “test ” that actually detects and diagnoses an anomaly sign on the basis of the model and an input signal. Basically, the former is an off-line process, and the latter is an on-line process. In the description below, these are distinguished from each other in terms of “on learning” and “on test”.

Equipment 101 as a target of status monitoring is equipment or a plant, such as a gas turbine or a steam turbine. The equipment 101 outputs a sensor signal 102 representing the status, and an event signal 103. A mode division unit 104 receives the event signal 103 as an input and divides time according to changes in operating status. In the description below, the division is referred to as mode division, and the types of the operating status are referred to as modes. On learning, the normal state model creation unit 105 generates a feature vector from the sensor signal 102, learns for each mode using learned data selected by a certain method, and creates a normal state model.

On test, the anomaly measure calculation unit 106 calculates an anomaly measure on the basis of comparison between the normal state model and the feature vector as an test target. An anomaly identification unit 107 performs an anomaly determination by comparing the anomaly measure with a preset threshold.

On learning, an event sequence grouping unit 108 receives the event signal 103 as an input and extracts an event sequence, and groups event sequences by clustering based on the similarity. A causality extraction unit 109 learns causality between the event sequence and an alarm. On test, the event sequence grouping unit 108 receives the event signal 103 as an input and extracts the event sequence. An anomaly prediction unit 110 searches the learned event sequences for a sequence similar to the observed event sequence, and predicts occurrence of a strongly associated alarm on the basis of the learned causality.

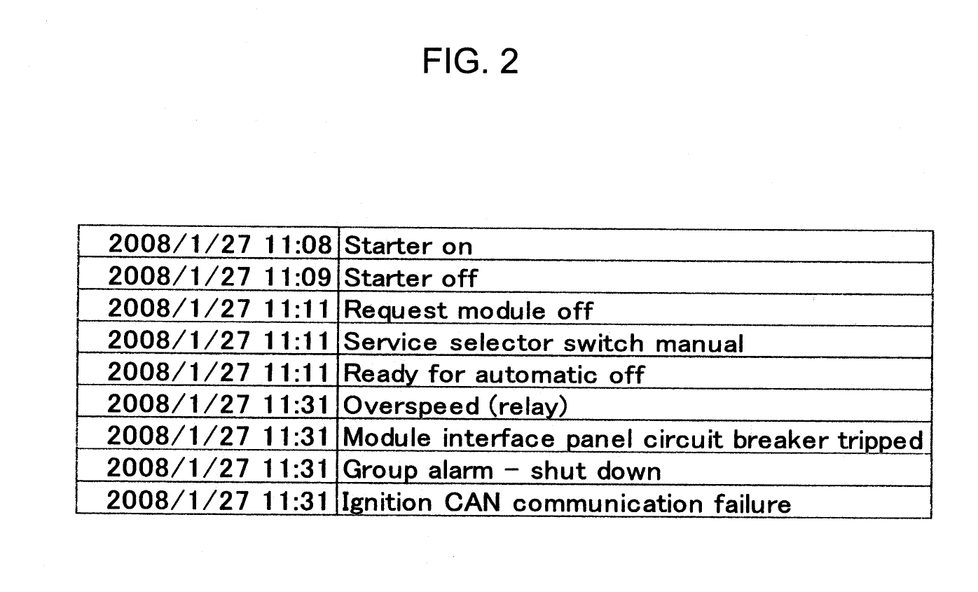

Next, operations of the each unit shown in FIG. 1 are described in detail. First, a mode division method in the mode division unit 104 will be described. FIG. 2 shows an example of the event signal. The event signal is output at irregular intervals, represents an operation, failure or warning of the equipment, and consists of a character string representing a time and an operation, failure or warning. This signal is input, and a start up sequence and a shut down sequence are extracted by searching for a prescribed event. More specifically, a start event and a finish event of the sequence are preliminarily designated and extracted while being scanned from the beginning to the end of event information according to following procedures.

(1) At a location out of the sequence, a start event is searched for. If the event is found, the event is regarded as the start of the sequence.

(2) At a location in the sequence, a finish event is searched for. If the event is found, the event is regarded as the end of the sequence. Further, a start event of a failure, warning or designation is searched for. If the event is found, the event is regarded as an anomaly termination of the sequence.

On the basis of a result of extracting the sequence, four types of modes, which are a “stationary OFF” mode from the finish time of the shut down sequence to the start time of the start up sequence, a “start up ” mode in the start up sequence, a “stationary ON” mode from the finish time of the start up sequence to the start time of the shut down sequence, and a “shut down” mode in the shut down sequence, are sequentially extracted, thereby dividing a period. The thus divided period in or out of the sequence is referred to as a “cluster”.

Such accurate division into the various operating status using the event information acquires simple statuses in terms of individual modes. Accordingly, a model of a subsequent normal status can accurately be created.

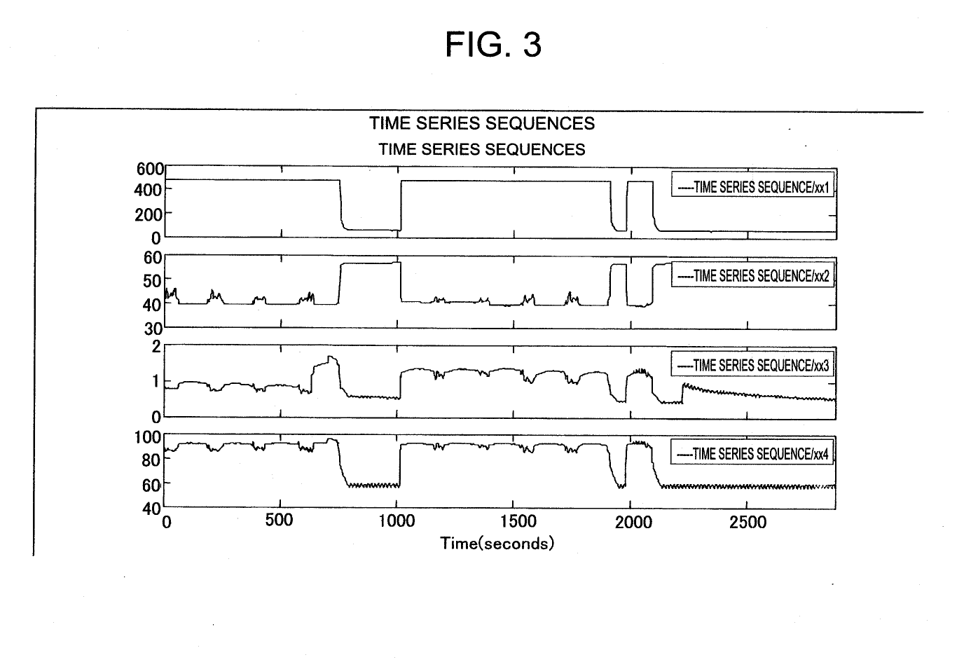

Next, a data processing method on learning in the normal state model creation unit 105, and an anomaly measure calculating method in the anomaly measure calculation unit 106 will be described with reference to FIGS. 3 to 6.

FIG. 3 shows an example of the sensor signal 102. The example is time series signals, and here represents four types of signals, or series 1, 2, 3 and 4. In actuality, the number of types is not limited to four. Instead, the number may be several hundreds or several thousands. The signals correspond to outputs from respective sensors provided with the equipment 101. For instance, temperatures of cylinders, oils, coolants and the like, pressures of oils and coolants, rotational speeds of axes, a room temperature, operation time and the like are observed at certain intervals. The signal may represent not only an output or a status, but also a control signal for controlling a certain element to a prescribed value. The present invention deals with the data as a multidimensional time series signal.

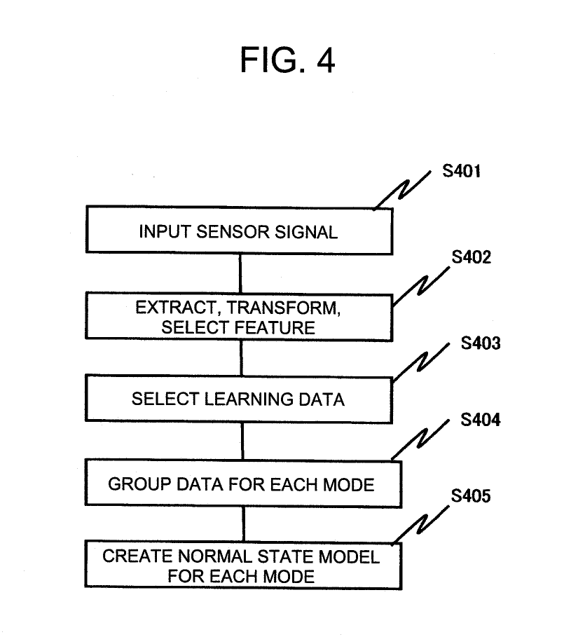

FIG. 4 shows a normal state model creation processing flow in the normal state model creation unit 105. In step S401, the sensor signal 102 is input. In step S402, feature selection, feature extraction and feature transformation are performed, and a feature vector is acquired. Although not shown, the sensor signal 102 is preliminarily accumulated, and signals in a designated period are received as inputs. The event signal 103 in the same period is also accumulated due to a mode division.

In the feature selection, sensor signals with a significantly small variance and monotonously increasing sensor signals are required to be removed. This removal is made as a minimum process. Further, it can be considered to delete invalid signals based on the correlation analysis. This deletion is a method that performs the correlation analysis on the multidimensional time series signal, and, in the case of significantly high similarity, such as the case with signals having a correlation value close to one, determines that the similarity represents redundancy and deletes a redundant signal from the signals to leave signals without redundancy. Instead, the process may be designated by a user. The selected sensors are stored so as to allow the identical sensors to be used on test.

In the feature extraction, it can be considered that the sensor signal is used as it is. Instead, windows of ±1, ±2, . . . may be provided for a certain time, and features representing temporal change of data can be extracted by means of feature vectors whose value is the window width (3, 5, . . . )×the number of sensors. Instead, discrete wavelet transform (DWT) may be applied to acquire frequency components.

Each feature may be normalized such that the average is converted into zero and the variance is converted into one, using the average and standard deviation. The average and standard deviation of each feature are stored so as to allow the same conversion on test. Instead, the normalization may be made using the maximum value and minimum value or preset upper limit and lower limit. These processes are for dealing with sensor signals with different units and scales, at the same time.

There are various methods for feature transformation including the principal component analysis (PCA), independent component analysis (ICA), non-negative matrix factorization (NMF), projection to latent structure (PLS), and canonical correlation analysis (CCA). Any method may be used. Combination thereof may be adopted. Conversion is not necessarily performed.

The PCA, ICA, and NMF are easy to use because the target variable is not required to be set. Parameters, such as a conversion matrix, necessary for conversion are stored so as to perform the same conversion on test as on the normal state model creation.

After the feature transformation, learned data is selected in step S403. In some cases, the acquired multidimensional time series is partially lost. Such data is deleted. For instance, in the case where most of the sensor signals are output as zero at the same time, the entire signal data at the corresponding time is deleted. Next, abnormal signal data is deleted.

More specifically, the event signal 103 is searched for the time when a warning or failure occurs. The entire signal data in the cluster (the period sequentially extracted in the mode division) including the time is removed. Next, in step S404, the data is grouped according to each mode. In step S405, a normal state model is created for each mode.

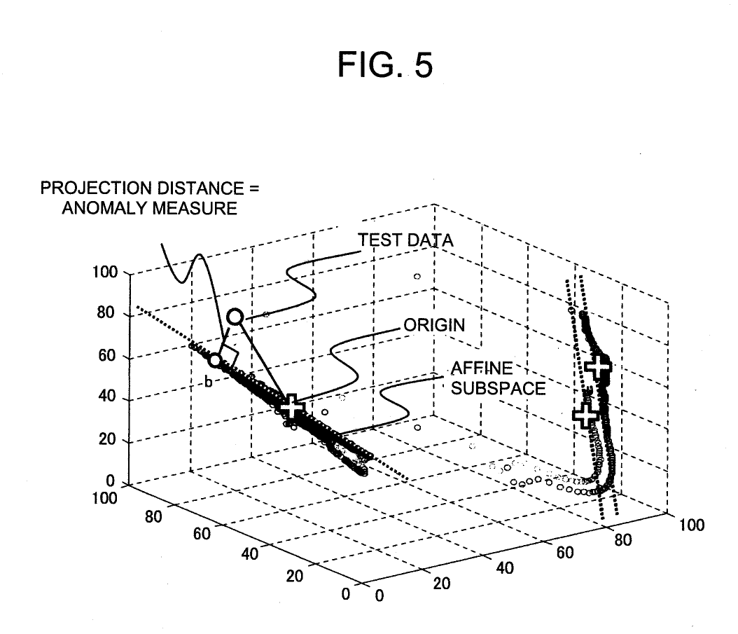

The normal state model creation method may be the projection distance method (PDM) or local sub-space classifier (LSC). The projection distance method creates a subspace having an individual origin for the learned data, which is an affine subspace (a space having the maximum variance). As described in FIG. 5, the affine subspace is created for each cluster.

The drawing shows an example where a one-dimensional affine subspace is created in a three-dimensional feature space. The number of dimensions of the feature space may be larger. Any number of dimensions of the affine subspace may be adopted, provided that the number is smaller than the number of feature space and smaller than the number of pieces of learned data.

A method of calculating an affine subspace will be described. First, the average μ and the covariance matrix Σ of learned data are acquired. Next, the eigenvalue problem of Σ is solved, and a matrix U, in which eigenvectors corresponding to respective r eigenvalues preliminarily designated from the eigenvalue having a larger value are arranged, is regarded as the normal orthogonal base of the affine subspace.

The anomaly measure calculated in the anomaly measure calculation unit 107 is defined as the minimum value of the projection distance d of each cluster onto the affine subspace; the cluster belongs to the mode identical to that of the test data acquired from the sensor signal 102 through the feature extraction unit 105. Here, instead of creating the affine subspace for each cluster, the affine subspace may be created by collecting all the clusters in the same mode. This method allows the number of calculating the projection distance to be reduced, and enables the anomaly measure to be calculated at high speed. The calculation of the anomaly measure is basically a real time process.

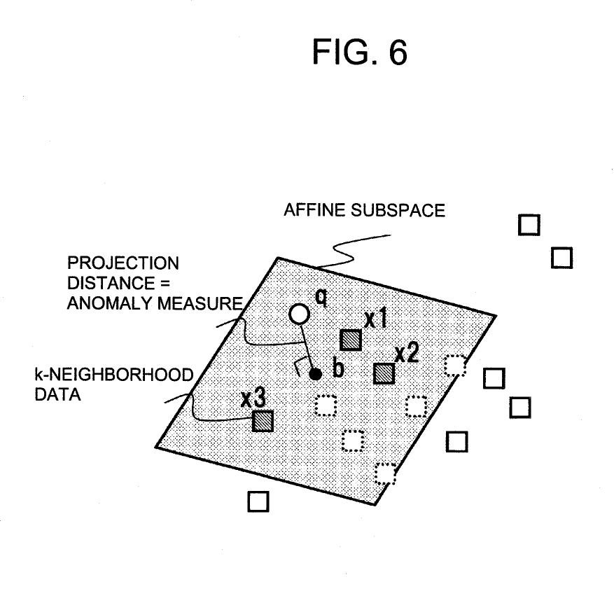

On the other hand, the local sub-space classifier creates the (k−1)-dimensional affine subspace using k-neighborhood data of test data q. FIG. 6 shows an example of the case of k=3. As shown in FIG. 6, the anomaly measure is represented by the illustrated projection distance. Accordingly, it is suffice to acquire the point b on the affine subspace closest to the test data q.

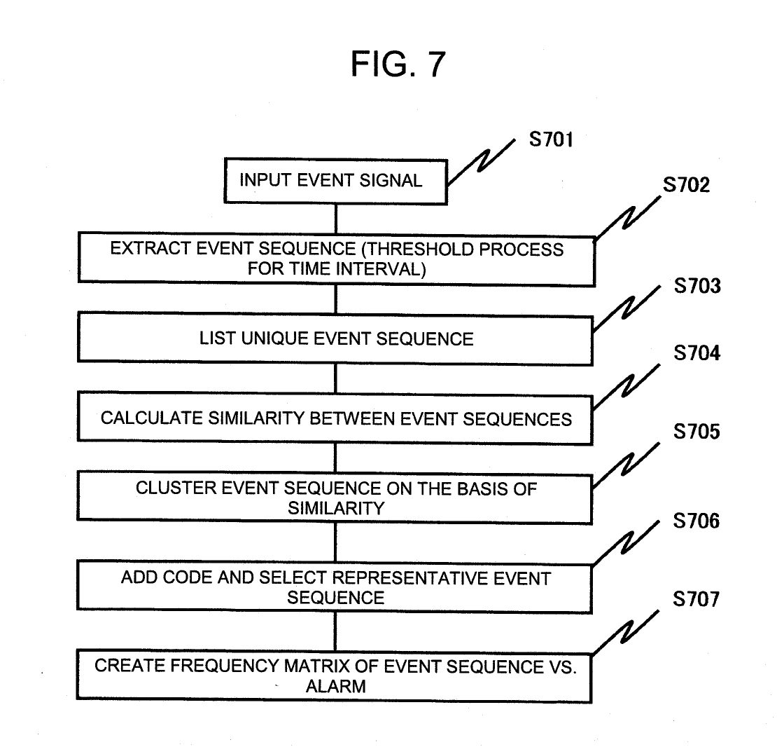

This method cannot create the affine subspace without inputting test data. Accordingly, in the normal state model creation unit 105, the processing up to data grouping for each mode as shown in FIG. 7 is performed, and a kd-tree for efficiently searching for k-neighborhood data is further constructed for each mode. The kd-tree has a space division data structure that groups points in the k-dimensional Euclidean space. The division is performed using only a plane perpendicular to one of the coordinate axes, and it is configured such that one point is stored in each leaf node. The anomaly measure calculation unit 106 acquires the k-neighborhood data of the test data using the kd-tree belonging to the same mode as that of the test data, then acquires the aforementioned point b, calculates the distance between the test data and the point b, and regards the distance as the anomaly measure.

Instead thereof, various methods, such as the Mahalanobis-Taguchi method, regression analysis method, nearest neighbor method, similarity based modeling, and one-class SVM, can create the normal state model.

Next, anomaly prediction using the event signal in the event sequence grouping unit 108, the causality extraction unit 109 and the anomaly prediction unit 110 will be described with reference to FIGS. 7 to 10. As described above, the event signal 103 is output at irregular intervals, represents an operation, failure or warning of the equipment, and consists of a character string representing a time and an operation, failure, or warning.

FIG. 7 shows a processing flow for learning causality between the event sequence and the alarm. In event sequence grouping unit 108, in step S701, the event signal 103 is input. In step S702, in the case where the time interval becomes equals to or more than the threshold, a separation process is performed and the event sequence is created. Next, in step S703, all the unique event sequences are listed. In step S704, the similarity between event sequences is examined. For instance, provided that the lengths of the event sequences are L1 and L2 and the number of deleting and adding events required to change one to the other is C, the similarity is represented as follows.

(L1+L2−C)/(L1+L2) Expression 1.

For instance, provided that one event sequence is aabc and the other is abb, L1=4, L2=3, C=3 (deletion of a ands from the former and addition of b thereto acquire the latter) and thereby the similarity is 4/7=0.571.

Next, in step S705, clustering based on the similarity between event sequences, that is, groping of similar event sequences is performed. In step S706, a unique code is added to each group, and a representative event sequence of the group is determined. For instance, the event sequence having the highest minimum value of the similarity with the event sequence in the group is selected as the representative event sequence. Instead, event sequences having a low similarity therebetween are selected. Next, in step S707, in the causality extraction unit 109, the frequency matrix between the event sequence and the alarm is created.

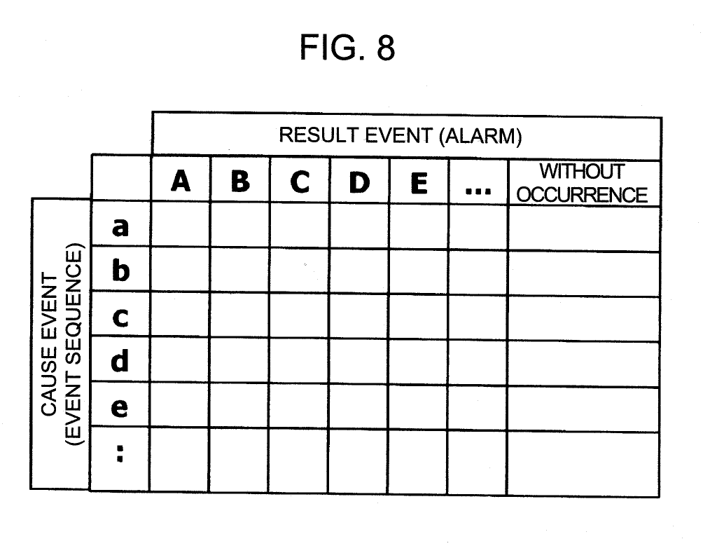

FIG. 8 shows an example of the frequency matrix. The alarm is extracted from the event signal 103 and a result event list is created, and “without occurrence” is added to the result event list. On the other hand, the grouped event sequence is regarded as a cause event. A frequency matrix where the abscissa indicates result events and the ordinate indicates cause events is created. First, all the elements in the matrix is reset to zero.

The alarms occurred in an interval until a preliminarily designated time has elapsed are examined for each event sequence. Elements are counted in an intersection between the code of the group to which the event sequence belongs and the alarm having occurred. If no alarm has occurred, the element “without occurrence” is counted. Further, the frequency of the event sequence belonging to each group is examined. Here, types of the elapsed time from the event sequence to the alarm are designated, and individual matrices are created, which allows the causality to be extracted according to characteristics of early occurrence of a sign or occurrence thereof immediately beforehand, and enables the time up to occurrence of the alarm to be roughly predicted.

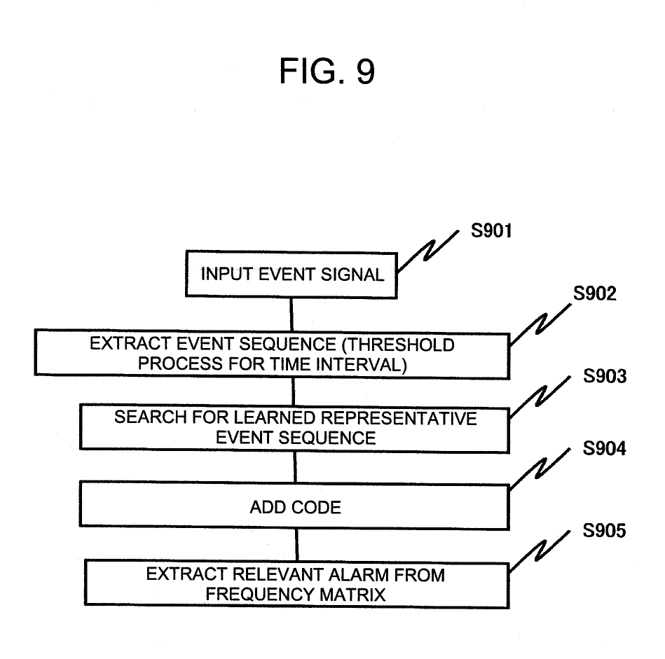

FIG. 9 shows a processing flow for predicting an anomaly using the created frequency matrix. This process is basically a real time process. First, as with the case on learning, in the event sequence grouping unit 108, in step S901, the event signal 103 is input. In step S902, in the case where the time interval becomes equals to or more than the threshold, a separation process is performed and the event sequence is created. Next, in step S903, the similarity with the representative event sequence of each group is calculated. In step S904, the code of the group having the highest similarity is added.

Next, in the anomaly prediction unit 110, in step S905, the row of the frequency matrix corresponding to the added code is examined, and determination is made as to whether the strongly associated alarm, that is, an alarm with a high probability of occurring exists for the designated event sequence group or not; if the alarm exists, occurrence of the alarm is predicted. The probability of occurring is calculated by dividing the frequency of each alarm on the row concerned by the frequency of the event sequence belonging to the group.

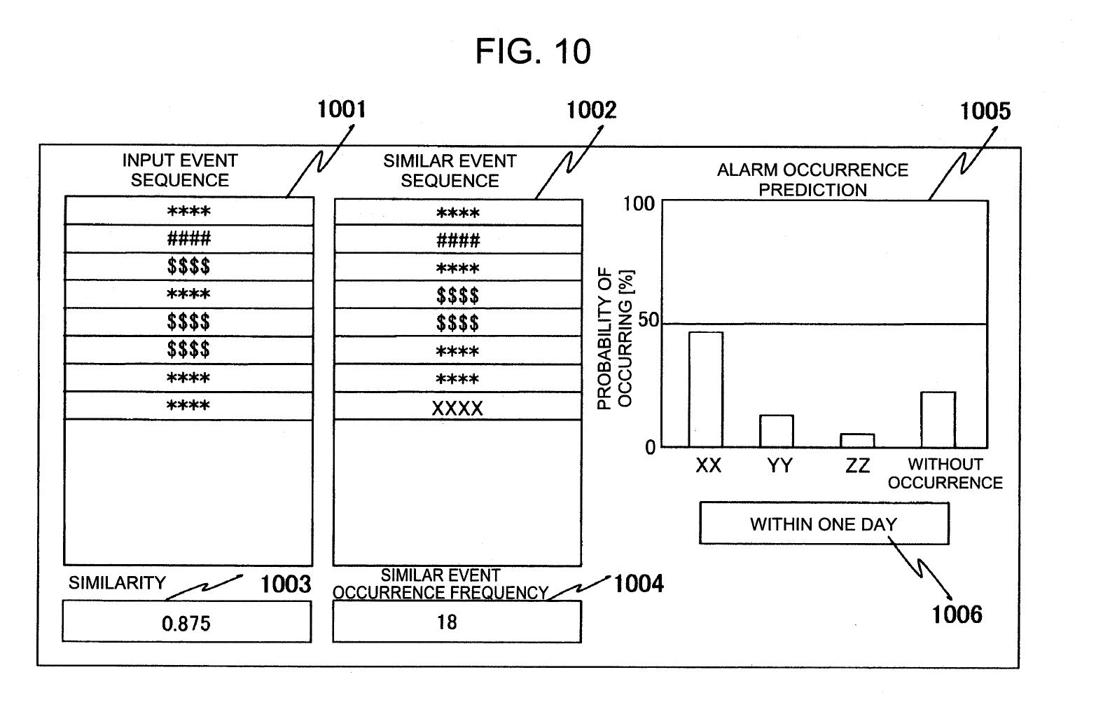

FIG. 10 shows an example of a screen for presenting an alarm occurrence prediction result. The input event sequence when occurrence of the alarm is predicted is displayed in an input event sequence display window 1001. The representative event sequence of the learned event sequence group having the highest similarity with the input event sequence is displayed in a similar event sequence display window 1002.

The similarity between the input event sequence and the similar event sequence is displayed in a similarity display window 1003. The number of event sequences on learning that belongs to the group of the displayed similar event sequence is displayed in a similar event occurrence frequency window 1004. In an alarm occurrence prediction display window 1005, a graph displays the probability of occurring of an alarm calculated from a row of the similar event sequence in the frequency matrix. The ordinate indicates the probability of occurring. The abscissa indicates the types of alarms. Instead of displaying all the alarms, only the probabilities of superior alarms and “without occurrence” are displayed. In the example shown in the drawing, the probabilities of occurring of three superior alarms are displayed.

The occurrence time is displayed in an occurrence time display window 1006 in the form of “within . . . ”. An elapsed time designated when the frequency matrix is calculated is entered in the portion “ . . . ”. Such display allows user to confirm both the occurred event sequence and previous events as a basis for alarm occurrence prediction. Information on the similarity, similar event occurrence frequency, and probability of occurring of an alarm can be adopted as standards for determining the degree of reliability of the predicted result.

In the case where the matrix is created for each elapsed time, the alarm occurrence time is predicted by examining the probability of occurring of the same alarm for each elapsed time. For instance, in the case where matrices are created for three elapsed times of t1, t2 and t3 (t1<t2<t3), if all the probabilities of occurring for t1, t2 and t3 on a certain alarm are high, it is predicted that the alarm occurrence time is within t1 hour from the event sequence observation. If the probability of occurring is low at t1 and high at t2, it is predicted that the alarm occurrence time is between t1 to t2 hour from the event sequence observation. Instead, the probabilities of occurring for the respective elapsed times may be presented.

The above process allows anomaly prediction by searching for the event sequence, even on a failure of a unit incapable of acquiring a sensor signal. The perspective of event sequences instead of individual events facilitates understanding of significance of the occurred event. Further, instead of dealing with the event sequence as it is, the event sequence is grouped to reduce the number of rows of the frequency matrix, thereby allowing statistically significant information to be increased.

Another embodiment of the event grouping method in the event sequence grouping unit 108 will be described. In this embodiment, before the grouping of event sequences by clustering, the start up sequence and the shut down sequence are assigned with respective unique event sequence codes using the result of extraction of the sequence in the mode division unit 104. Different event sequence codes are preferably defined to a normally completed sequence and an anomaly termination sequence.

Further, the anomaly termination sequences may be differentiated and defined according to a sequence terminated in a failure event, a sequence terminated in a warning event, and a sequence terminated in a sequence start event. The event sequences may be grouped on the basis of the number of specific events in the sequence. Instead, the sequences may be grouped on the basis of the time interval between specific events.

In the case with a standardized sequence other than the start up and shut down sequences, it is preferable that the start event and finish event of the sequence be designated, extracted simultaneously with the start up and shut down sequences, and a different event sequence code is added thereto. Further, the extracted sequences may be grouped by a method similar to the method for the start up and shut down sequences, and different codes may be added thereto.

After addition of the codes to the specific sequence, the corresponding event sequence is removed, and the events are grouped by clustering. Processes thereafter are similar to the aforementioned methods. It can be considered that such processes allow the knowledge on the events to be reflected, which in turn allows more useful grouping of event sequences.

The aforementioned configuration can realize an equipment status monitoring system that can create the normal state model on the basis of the multidimensional time series sensor signal and calculate the anomaly measure on the basis of comparison between the normal state model and the sensor signal, while identifying an anomaly, predict an anomaly even on a unit incapable of acquiring the sensor signal by means of grouping the event signal.

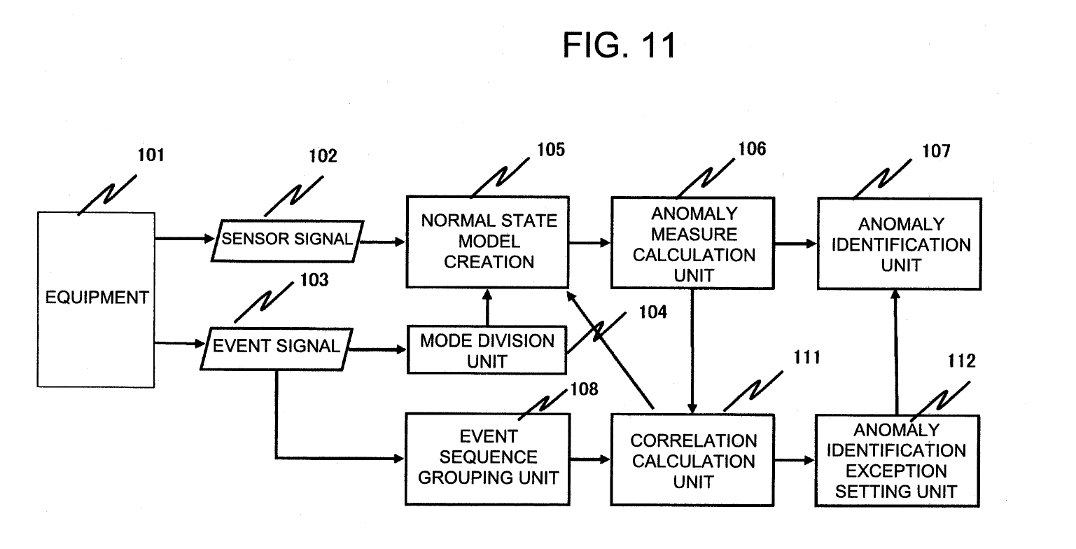

Another embodiment of an equipment status monitoring method of the present invention will be described with reference to FIGS. 11 to 13. FIG. 11 is a diagram showing a configuration of an equipment status monitoring system realizing this embodiment. The equipment 101 as a target of status monitoring outputs a sensor signal 102 representing the status, and an event signal 103. The mode division unit 104 receives the event signal 103 as an input and divides time according to changes in operating status.

On learning, the normal state model creation unit 105 generates a feature vector from the sensor signal 102, learns for each mode using learned data selected by a certain method, and creates a normal state model. The anomaly measure calculation unit 106 calculates an anomaly measure on the basis of comparison between the normal state model and the feature vector as an test target. Here, cross validation method, such as k-fold cross validation, is applied to prevent the learned data and the data as a target of anomaly measure calculation from being identical to each other. The event sequence grouping unit 108 receives the event signal 103 as an input and extracts event sequences, and groups the event sequences. A correlation calculation unit 111 calculates a correlation between the average of anomaly measures in a certain period and presence or absence of specific event sequence occurrence. An anomaly identification exception setting unit 112 sets whether to regard an event sequence having a significantly high anomaly measure as an exception of anomaly identification or not. In the normal state model creation unit 105, data in a period including the event sequence having a significantly high anomaly measure is removed from learned data and then the normal state model is created again.

On test, the anomaly measure calculation unit 106 calculates an anomaly measure on the basis of comparison between the normal state model and the feature vector as an test target. The anomaly identification unit 107 detects an anomaly by comparing the anomaly measure with a preset threshold and determining whether the measure is an exception of anomaly identification or not.

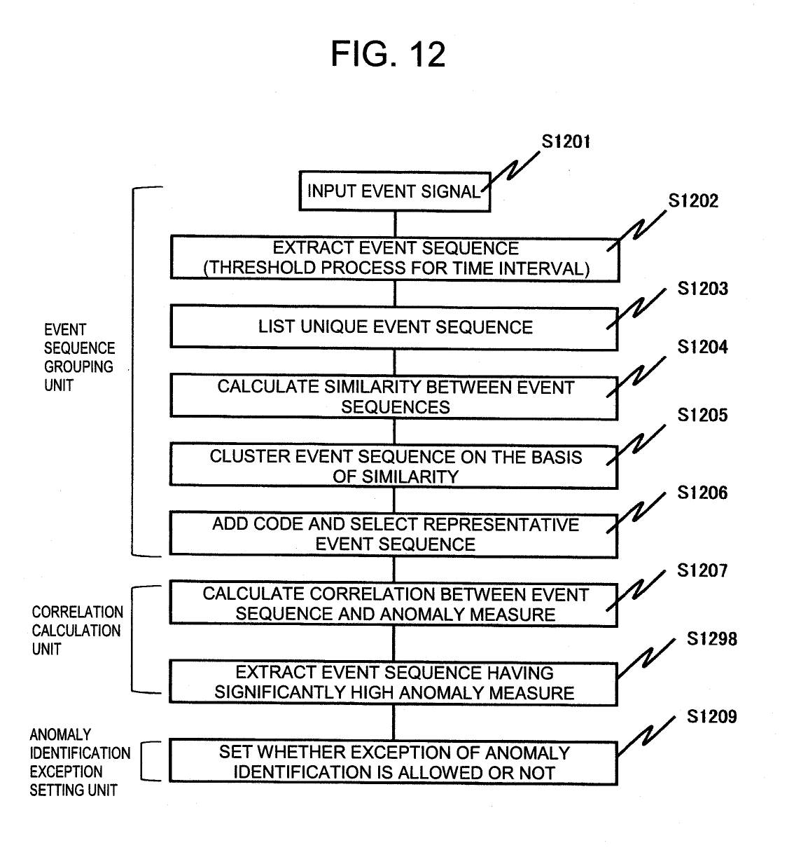

FIG. 12 shows a processing flow on learning in the event sequence grouping unit 108, the correlation calculation unit 111 and the anomaly identification exception setting unit 112. In the event sequence grouping unit 108, in step S1201, the event signal 103 is input. In step S1202, in the case where the time interval becomes equals to or more than the threshold, a separation process is performed and the event sequence is created.

Next, in step S1203, all the unique event sequences are listed. In step S1204, similarity between event sequences is examined. In step S1205, clustering based on the similarity between event sequences is performed. In step S1206, a unique code is added to each group, and a representative event sequence of the group is determined. Next, in the correlation calculation unit 111, in step S1207, a correlation is calculated between the average of anomaly measures in the certain period and presence or absence of a specific event sequence.

More specifically, it is examined whether a certain event occurs in a certain period, such as each day, or not. The averages and variances in a period with and without occurrence of the event are calculated. In step S1208, determination is made as to whether there is a significant difference or not according to variance analysis. Instead, the average of anomaly measures is calculated for each certain period. Histograms for the periods with and without occurrence of a certain event are separately calculated. Determination is made as to whether there is a significant difference on the basis of the size of overlapping of the histograms.

The processes up to here have acquired information on the event sequence having a significantly high anomaly measure. The information is used for selecting learned data when a normal state model is created on the basis of the sensor data, thereby allowing a highly accurate model to be created. Next, in the anomaly identification exception setting unit 112, in step S1209, it is set whether to allow an exception of the anomaly identification or not.

The representative event sequences of all the event sequence groups having a significantly high anomaly measure are displayed on GUI. This display allows the user to select whether an exception of anomaly identification is allowed or not. For instance, the event sequence representing a manual operation, such as a maintenance operation, is preferably set as an exception. Thus, information in a period where an anomaly should not be detected, such as that for the maintenance operation, can be acquired.

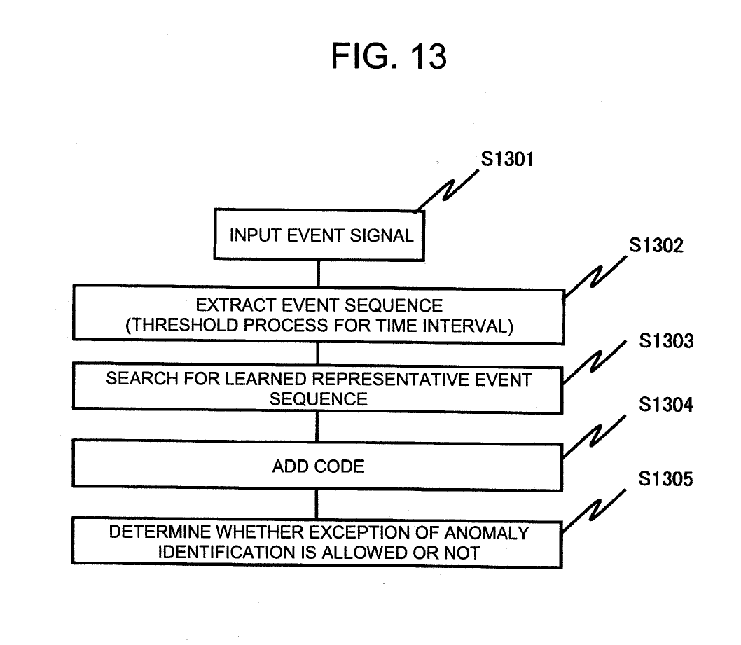

FIG. 13 shows a processing flow on test in the event sequence grouping unit 108, the correlation calculation unit 111 and the anomaly identification exception setting unit 112. First, as with the case on learning, in the event sequence grouping unit 108, in step S1301, the event signal 103 is input. In step S1302, in the case where the time interval becomes equal to or more than the threshold, a separation process is performed and the event sequence is created. Next, in step S1303, similarity with the representative event sequence in each group is calculated. In step S1304, the code of the group having the highest similarity is added. Finally, in step S1305, determination is made as to whether to allow an exception of anomaly identification or not according to the setting on learning.

This information is used for anomaly identification based on the sensor data in the anomaly identification unit 107. More specifically, even if the calculated anomaly measure exceeds the preset threshold, the anomaly is not determined at the time determined as an exception of anomaly identification. This process can prevent an anomaly of the sensor output due to the manual operation from being detected.

FIG. 10 shows the configuration without the causality extraction unit 109 and the anomaly prediction unit 110. However, a configuration also including the means and processing flow is also encompassed by the present invention.

### REFERENCE SIGNS LIST

101 Equipment
102 Sensor signal
103 Event signal
104 Mode division unit
105 Normal state model creation unit
106 Anomaly measure calculation unit
107 Anomaly identification unit
108 Event sequence grouping unit
109 Causality extraction unit
110 Anomaly prediction unit
111 Correlation calculation unit
112 Anomaly identification exception setting unit
1001 Input event sequence display window
1002 Similar event sequence display window
1003 Similarity display window
1004 Similar event occurrence frequency window
1005 Alarm occurrence prediction display window
1006 Occurrence time display window

1. An equipment status monitoring method detecting an anomaly on the basis of a time series sensor signal and event signal output from equipment or a device, comprising:
extracting event sequences from the event signal;
grouping the event sequences on the basis of similarity between the event sequences; and
detecting an anomaly using a result of the grouping of the event sequences.

2. An equipment status monitoring method detecting an anomaly on the basis of a time series event signal output from equipment or a device, comprising:
extracting event sequences from the event signal;
grouping the event sequences on the basis of similarity between the event sequences;
extracting an alarm from the event signal;
associating a group of the event sequences with the alarm to calculate frequency matrix;
grouping the event sequence observed on test on the basis of similarity with the learned event sequence; and
predicting occurrence of an alarm strongly associated with the group of the event sequences on the basis of the frequency matrix.

3. The equipment status monitoring method according to claim 2, further comprising:
extracting a feature vector on the basis of the sensor signal output from the equipment or the device to be monitored;
creating a normal state model on the basis of the feature vector, on learning;
calculating an anomaly measure by comparing the normal state model with the feature vector, on detecting of the anomaly; and
an anomaly is identified by comparing the anomaly measure with a preset threshold.

4. The equipment status monitoring method according to claim 2, further comprising:
performing mode division for each operating status on the basis of the event signal;
extracting the feature vector on the basis of the sensor signal output from the equipment or the device to be monitored;
creating a normal state model for each mode on the basis of the feature vector, on learning;
calculating an anomaly measure by comparing the normal state model with the feature vector, on detecting of the anomaly; and
identifying the anomaly by comparing the anomaly measure with a preset threshold.

5. The equipment status monitoring method according to claim 4, wherein the mode division includes: inputting the event signal; preliminarily designating start and finish events of a plurality of sequences; and extracting a period in the sequence or between the sequences while sequentially searching for the start and finish events.

6. The equipment status monitoring method according to claim 2, wherein the creating the frequency matrix includes: acquiring a result event by adding “without occurrence” to the alarm; regarding the group of the event sequences as a cause event; setting every element of the matrix to be zero; examining the alarm generated in an interval until a preliminarily designated time has elapsed, for the event sequence; counting the element at an intersection of the group to which the event sequence belongs with the generated alarm, if the generated alarm exists; and counting the element at an intersection of the group to which the event sequence belongs with “without occurrence”, if no generated alarm exists.

7. The equipment status monitoring method according to claim 6, wherein the creating the frequency matrix includes: preliminarily designating a plurality of times as the preset time; and individually creating the frequency matrices corresponding to the respective times.

8. The equipment status monitoring method according to claim 7, further comprising estimating an alarm occurrence time using the frequency matrices corresponding to the respective plurality of times.

9. An equipment status monitoring method detecting an anomaly on the basis of a time series sensor signal and event signal output from equipment or a device, comprising:
performing mode division for each operating status on the basis of the event signal;
extracting the feature vector on the basis of the sensor signal;
creating a first normal state model for each mode on the basis of the feature vector;
calculating a first anomaly measure by comparing the first normal state model with the feature vector;
extracting an event sequences from the event signal;
grouping the event sequences on the basis of similarity between the event sequences;
extracting the event sequence having a significantly high anomaly measure on the basis of correlation between presence or absence of occurrence of the grouped event sequence and the first anomaly measure;
creating learned data by removing data in a prescribed period during which the event sequence having the significantly high anomaly measure has been occurred, from the feature vector;
creating a second normal state model for the each mode using the learned data;
calculating a second anomaly measure by comparing the second normal state model with the feature vector; and
identifying an anomaly by comparing the second anomaly measure with a preset threshold.

10. The equipment status monitoring method according to claim 9, further comprising:
presetting whether to allow the event sequence having the significantly high anomaly measure as an exception or not; and
canceling the anomaly determination by the anomaly identification in a prescribed period during which the event sequence set as the exception has been occurred.

11. An equipment status monitoring system, comprising:
equipment to be monitored that outputs a time series sensor signal and an event signal;
a mode division unit performing mode division for each operating status on the basis of the event signal;
a normal state model creation unit that extracts a feature vector on the basis of the sensor signal to create a normal state model;
an anomaly measure calculation unit calculating an anomaly measure by comparing the normal state model with the feature vector;
an anomaly identification unit identifying an anomaly by comparing the anomaly measure with a preset threshold;
an event sequence grouping unit that groups event sequences from the event signal on the basis of similarity of extraction;
a causality extraction unit that associates a group of the event sequences with an alarm extracted from the event signal, and calculates a frequency matrix; and
an anomaly prediction unit that groups the event sequence to be observed on the basis of similarity with the learned event sequence, and predicts occurrence of an alarm strongly associated with the observed event sequence on the basis of the frequency matrix.

12. An equipment status monitoring system, comprising:
equipment to be monitored that outputs a time series sensor signal and an event signal;
a mode division unit performing mode division for each operating status on the basis of the event signal;
a normal state model creation unit that extracts a feature vector on the basis of the sensor signal to create a normal state model;
an anomaly measure calculation unit calculating an anomaly measure by comparing the normal state model with the feature vector;
an anomaly identification unit identifying an anomaly by comparing the anomaly measure with a preset threshold;
an event sequence grouping unit that extracts event sequences from the event signal, and groups the event sequences on the basis of similarity;
a correlation calculation unit that calculates correlation between presence or absence of occurrence of the grouped event sequence and the anomaly measure, and extracts the event sequence having a significantly high anomaly measure; and
an anomaly identification exception setting unit setting whether to allow the event sequence having the significantly high anomaly measure as an exception of anomaly identification or not.

13. An equipment status analysis program causing a computer to execute:
a step of receiving, as an input, a time series event signal output from equipment or a device;
a step of extracting event sequences from the event signal;
a step of grouping the event sequences on the basis of similarity between the event sequences; and
a step of associating a group of the event sequences with an alarm extracted from the event signal, and calculating a frequency matrix.

14. An equipment status analysis program causing a computer to execute:
a step of receiving, as inputs, a time series sensor signal and event signal output from equipment or a device;
a step of performing mode division for each operating status on the basis of the event signal;
a step of extracting a feature vector on the basis of the sensor signal;
a step of creating a first normal state model for the each mode on the basis of the feature vector;
a step of calculating an anomaly measure by comparing the first normal state model with the feature vector;
a step of extracting an event sequences from the event signal;
a step of grouping the event sequences on the basis of similarity between the event sequences;
a step of calculating correlation between occurrence of a group of the event sequences and the anomaly measure;
a step of extracting a group of event sequences having a significantly high anomaly measure on the basis of the correlation;
a step of creating learned data by removing data in a prescribed period during which the event sequence having the significantly high anomaly measure has been occurred, from the feature vector; and
creating a second normal state model for the each mode using the learned data.
